(19) United States
(12) Patent Application Publication
(10) Pub. No.: US 2014/0268146 A1
(43) Pub. Date: Sep. 18, 2014

(54) LENSLET ARRAY WITH INTEGRAL TUNED OPTICAL BANDPASS FILTER AND POLARIZATION

(71) Applicant: Michele Hinnrichs, Solvang, CA (US)

(72) Inventor: Michele Hinnrichs, Solvang, CA (US)

(21) Appl. No.: 14/211,206

(22) Filed: Mar. 14, 2014

Related U.S. Application Data
(60) Provisional application No. 61/789,208, filed on Mar. 15, 2013.

(51) Int. Cl. G01J 3/46

(52) U.S. Cl. CPC G01J 3/46
USPC 356/364; 356/416

(57) ABSTRACT

A spectral radiation detector employs at least one lenslet with a circular blazed grating for diffraction of radiation at a wavelength at nth order to a focal plane A detector is mounted at the focal plane receiving radiation passing through the at least one lenslet for detection at a predetermined order. At least one order filter associated with the at least one lenslet passes radiation at wavelengths corresponding to the predetermined order. In additional embodiments a polarizing filter is associated with the lenslet for additional discrimination of the radiation.

### REFERENCE TO RELATED APPLICATIONS

This application claims priority of U.S. provisional application Ser. No. 61/789,208 filed on Mar. 15, 2013 the disclosure of which is incorporated herein by referenced.

### BACKGROUND

1. Field

This invention relates generally to the field of diffractive lenslet optics for spectral imaging and more particularly to a diffractive lenslet array having an integrated filter for enhanced detection of higher order wavelength and an integrated filter for selected polarization of individual lenslets.

2. Description of the Related Art

Spectral imaging may be accomplished using circular blazed grating diffractive lenslet arrays to discriminate various wavelengths. The preparation of diffractive lenslets for radiation, such as radiation in the visible and infrared bands, requires precision grinding to provide appropriate blazing. Additional precision in discrimination of properties of the incoming radiation to a detector for depth measurement in a substance or other characteristics is also desired. Spectral imaging may be employed for remote sensing.

It is therefore desirable to provide a spectral imaging lenslet system which reduces the precision required for blazing or conversely enhances detection at a given precision and provides additional discrimination capability.

### SUMMARY

The embodiments disclosed herein overcome the shortcomings of the prior art by providing a spectral radiation detector having at least one lenslet with a circular blazed grating for diffraction of a wavelength to a focal plane. A detector is mounted at the focal plane receiving radiation passing through the at least one lenslet for detection. At least one order filter associated with the at least one lenslet passes radiation at wavelengths corresponding to a predetermined order.

Implemented in an array embodiment, the spectral radiation detector includes a collimating lens passing radiation that is parallel in the spectral bands of interest with an array of lenslets for a set of wavelengths that receives in band radiation from the collimating lens, each lenslet having a circular blazed grating for diffraction of an associated wavelength from the set at the focal plane. A detector at the focal plane receives radiation passing through the array of lenslets for detection of wavelengths at a predetermined order in the bandpass of interest. An array of order filters equal in number to the array of lenslets is provided. Each order filter in the array is associated with a lenslet of the array and positioned in the optical path between the collimating lens and the detector to pass radiation at wavelengths corresponding to the predetermined order in the bandpass of interest

For an additional aspect, a polarizing filter may be associated with the lenslets. For the array embodiment, the array of lenslets includes at least two lenslets for each wavelength in the set and further at least two polarizing filters having different polarization are each associated with a respective one of the at least two lenslets for each wavelength.

These and other features and advantages of the present invention will be better understood by reference to the following detailed description of exemplary embodiments when considered in connection with the accompanying drawings.

### BRIEF DESCRIPTION OF THE DRAWINGS

FIG. 1 is a schematic side view of a spectral radiation detector employing a first embodiment;

FIG. 2 is a detailed front view of the lenslet array employed in the spectral radiation detector;

FIG. 3 is a side view of the lenslet array with an integral thin film order filter array integrated on the same substrate;

FIG. 4 is a side view of the lenslet array with a Fabry-Perot filter as the order filter mounted in front of the lenslet array;

FIGS. 5A and 5B are side and rear views of an example lenslet in the lenslet array;

FIG. 6 is a graphical representation of diffraction efficiency as a function of wavelength and order for an example lenslet and order filter;

FIG. 7 is a schematic side view of the spectral radiation detector further including a polarizing filter element;

FIG. 8 is a front view of a polarizing filter quad;

FIGS. 9 and 10 are front and side views of a lenslet array demonstrating lenslet quads associated with polarizing filter quads;

FIG. 11 is a blow up view of polarizing filter quads associated with the lenslet quads of the array of FIG. 9; and,

FIG. 12 is a side view of an example single lenslet with the order filter and polarizing filter integrated in thin film technology on the same substrate.

### DETAILED DESCRIPTION

Embodiments shown in the drawings and described herein provide a lenslet array in which each lenslet is designed for diffraction of a predetermined wavelength of radiation at a desired focal length. A focal plane array (FPA) as a detector receives radiation transmitted through the lenslet array for detection of radiation wavelengths selected by diffraction order from each lenslet. A diffraction order filter is employed to segregate higher and/or lower order diffracted wavelengths and pass only the selected diffraction order to the FPA. Further discrimination of the incoming radiation is accomplished by providing in the array multiple lenslets for each desired wavelength and associating a polarization filter of desired orientation with each of the same wavelength lenslets.

Referring to the drawings, FIG. 1 shows an example spectral radiation detector 10 having a Dewar enclosure 12 with a window 14. A collimating lens 16 provides collimated radiation to a diffraction array 18 having circular blazed grating lenslets 20 for N wavelengths, to be described in greater detail subsequently. A FPA 22 receives radiation from the diffraction array 18 with light baffles 24 incorporated intermediate the array and FPA for segregation of radiation from the individual lenslets 20. An order filter 26 is associated with the lenslet array in the optical path between the collimating lens 16 and FPA22. For the example embodiment the order filter 25 is mounted between the collimating lens 16 and diffraction array 18. Order filter 26 comprises an array of separate filter elements 28 associate with each lenslet 20 in the lenslet array 18

An example lenslet array 18 is shown in FIG. 2 with 16 individual lenslets 20a-20p. Each lenslet is blazed to provide radiation to the focal plane at the FPA for a wavelength, λ, and a higher order, for a second wavelength, λ′. For an exemplary embodiment described in detail herein 3^{rd} order is employed as the selected higher order. For example, lenslet 20a provides 1^{st} order diffraction for λ₁ of 4.35 microns and 3^{rd} order diffraction of λ₁′ at 1.45 microns. Filter 26 is employed to pass radiation wavelengths closely surrounding the 3^{rd} order wavelengths for each of the lenslets thereby providing the FPA with radiation having high sensitivity because the other order radiation is filtered out, as will be described in greater detail subsequently. For an example embodiment as shown in FIG. 2 for the lenslet array 18, a unique order filter for each lenslet is employed to keep both higher and lower order of diffracted radiation from leaking through thereby allowing detection of a selected order or spectral bandwidth (3^{rd} order in the example) which may have better properties for detection by the FPA than the 1^{st} order wavelength passed by the diffracting lens. For this example 16 different bandpass order filters to filter out 90% of higher and lower orders of light for each of the 16 elements in the 4×4 lenslet array with each of the lenslets designed at 1^{st} order but used at 3^{rd} order is shown. The 1^{st} order design wavelength, 3^{rd} order detection wavelength and the bandpass characteristics of individual filter elements 28 of the order filter 26 are shows in Table 1 below. The embodiment described employs a bandpass filter white alternative embodiments may employ single or paired high pass or low pass filters or single or paired notch filters for wavelengths adjacent the detection wavelength as may be desirable for greatest efficiency in detecting the desired order wavelength at the focal plane of the spectral radiation detector.

TABLE 1

| | | Used for | | Order | | |
|---|---|---|---|---|---|---|
| | Design | Detection | | Bandpass | | |
| | Wave- | Wave- | | Filter | | |
| Lens- | length | length | Filter | Low | High | Band- |
| let | 1^{st} order λ | 3^{rd} order λ’ | element | cutoff | cutoff | pass |
| 20p | 11.7 | 3.9 | 28p | 3.60 | 4.26 | 0.66 |
| 20o | 11.4 | 3.8 | 28o | 3.50 | 4.15 | 0.65 |
| 20n | 11.1 | 3.7 | 28n | 3.41 | 4.04 | 0.63 |
| 20m | 10.8 | 3.6 | 28m | 3.32 | 3.93 | 0.61 |
| 20l | 10.5 | 3.5 | 28l | 3.23 | 3.82 | 0.59 |
| 20k | 10.2 | 3.4 | 28k | 3.13 | 3.71 | 0.58 |
| 20j | 9.9 | 3.3 | 28j | 3.04 | 3.60 | 0.56 |
| 20i | 9.6 | 3.2 | 28i | 2.95 | 3.50 | 0.55 |
| 20h | 7.2 | 2.4 | 28h | 2.21 | 2.62 | 0.41 |
| 20g | 6.84 | 2.28 | 28g | 2.10 | 2.50 | 0.40 |
| 20f | 6.45 | 2.15 | 28f | 1.98 | 2.35 | 0.37 |
| 20e | 6.00 | 2.00 | 28e | 1.84 | 2.19 | 0.35 |
| 20d | 5.25 | 1.75 | 28d | 1.61 | 1.91 | 0.30 |
| 20c | 4.95 | 1.65 | 28c | 1.52 | 1.80 | 0.28 |
| 20b | 4.65 | 1.55 | 28b | 1.43 | 1.70 | 0.27 |
| 20a | 4.35 | 1.45 | 28a | 1.33 | 1.59 | 0.26 |

Filter 26 may be accommodated in various forms for the embodiments herein. The order filter 26 may be placed on a separate substrate placed between the collimating lens and the lenslet array as shown in FIG. 1 or between the lenslet array and the focal plane array. As shown in FIG. 3, order filter 26 may be embodied in thin film technology with each filter element 28 fabricated on the same substrate 30 as the lenslet array 18 on an opposite side from the blazed grating 32 of and associated with each lenslet 20. In alternative embodiments, other filter structures such as a Fabry-Perot filter 34 shown in FIG. 4 may be employed. Each Fabry-Perot filter element 36 associated with each lenslet 20 incorporates dual reflecting surfaces 38a and 38b supported in a spacing structure 40 for tuning of the filter element for the desired wavelength. In yet other alternative embodiments, Bragg grating cavities or fixed Fabry-Perot cavities may be employed for the filter elements

The exemplary lenslet array for the embodiment described employs 16 lenslets for 16 separate wavelengths. In alternative embodiments an array of 1 to n×n lenslets may be employed with a detector using the order detection and associated filters described.

The details of an exemplary lenslet 20 are shown in FIGS. 5A and 5B. The circular blazed grating 32 is fabricated on the substrate 30, for exemplary embodiments using photolithographic process (MEMS or MOEMS), having radii r1-rn with a maximum depth, dmax as shown in Table 2.

TABLE 2

| | | | | |
|---|---|---|---|---|
| Daimeter of lenslet | D | 3072 | (um) | |
| Radius of lenslet | R | 1536 | (um) | |
| Focal Length | f | 7 | (mm) | |
| f/# | f_num | 2.28 | (num) | |
| First phase coefficient | a | 0.07 | (mm\hat{ }− | 1/(2f) |
| | | | 1) | |
| Design Wavelength (first | lo | 4.35 | (um) | |
| order) | | | | |
| n_total | n | 39 | (num) | f/(8lo(f/#)\hat{ }2) |
| Refractive Index of material | No | 2.78 | | |
| dmax | d | 2.44 | (um) | lo/(No − 1) |
| Radius of center zone | r1 | 246.78 | (um) | sqrt(lo/a) |
| | r2 | 349 | (um) | r1 * sqrt(2) |
| | r3 | 427.43 | (um) | r1 * sqrt(3) |
| | r4 | 493.56 | (um) | r1 * sqrt(4) |
| | r5 | 551.82 | (um) | r1 * sqrt(5) |
| | r6 | 604.48 | (um) | r1 * sqrt(6) |
| | r7 | 652.92 | (um) | r1 * sqrt(7) |
| | r8 | 698 | (um) | r1 * sqrt(8) |
| | r9 | 740.34 | (um) | r1 * sqrt(9) |
| | rn − 1 | 1521.25 | (um) | r1 * sqrt(n − 1) |
| Radius to last zone | rn | 1541.14 | (um) | r1 * sqrt(n) |
| Delta r min | Drmin | 19.82 | (um) | 2 * lo * f/# |

The embodiment shown in FIG. 5A employs the thin film filter element 28 on the substrate 30 opposite the circular blazed grating 32. For the lenslet 20a as defined in table 1, FIG. 6 demonstrates the diffraction efficiency based on wavelength and order for the lenslet. The 1^{st} order, trace 602, has a center wavelength at 4.35 microns while the 3^{rd} order, trace 604, has a center wavelength at 1.45 microns. The 2^{nd} order trace 603 is also shown for reference. By providing a bandpass filter element 28a, represented by blocks 606 and 608, with a low cut off at 1.33 microns and a high cutoff at 1.59 microns very high rejection of crosstalk (above 90%) is isolated for transmission to the FPA 22 at the desired detection wavelength corresponding to the 3^{rd} order wavelength.

The lenslet array 18 for the embodiments as shown in FIG. 1 is translatable along an optical axis 42 to alter the focal length for tuning of the received wavelengths of radiation at the FPA detector as disclosed in U.S. Pat. No. 7,910,890 having a common assignee with the present application, the disclosure of which is incorporated herein by reference. Order filter 26 employs wavelength characteristics sufficient to accommodate wavelength shift for the variable focal length or, in the case of a Fabry-Perot filter or similar structure, may also be tunable separately or in conjunction with the translation of the lenslet array for a comparable wavelength shift. The filter can also be a fixed spectral bandpass for a lenslet array that is not translated along the optical axis, i.e. for multi-spectral imaging and not hyperspectral imaging.

The embodiments disclosed in FIG. 1 and described above divide an aperture associated with the collimating lens into images of different wavelengths associated with each lenslet in the lenslet array. Additional discrimination capability is created by the addition of a polarizing filter array 50 as shown in FIG. 7. Radiation entering the spectral radiation detector 10 is collimated by the collimating lens 16 and passed through a broadband filter 52. The order filter array 26, as previously described, passes radiation to the lenslet array 18 at a desired order wavelength for detection by the FPA 22. Polarizing filter array 50 provides up to four filter units as a filter quad having a polarized filter element 54a, 54b, 54c and 54d each associated with one of a set of four lenslets as shown in FIG. 8. For the embodiment shown in FIGS. 9 and 10, the 16 lenslets of FIG. 2 are replaced by 64 lenslets grouped in lens quads 56 with each lenslet in the quad blazed to provide radiation to the focal plane at the FPA at nth order for a wavelength, λ. The wavelengths defined in Table 1 would be examples of the wavelengths for the 16 quads 54 of the exemplary embodiment of FIG. 9. As shown in FIG. 11, the filter elements 54a-54d in each quad may be polarization film or pattern, for example a wire grid, and may be integrated on the same substrate as the lenslet array as shown in FIG. 12, with or without the thin film filter array, or on a separate substrate that is mechanically mounted in front of or behind the lenslets. The polarizers may be integrated with the order filter on a separate substrate. The array of lenslets for this form of embodiment can be as few as 2×2 or as many as n×n. Additionally, while shown for these embodiments as quads of four polarizing filters providing 0°, 90°, +45° and −45° of polarization, fewer polarizing filters with associated lenslets may be employed and the lenslet array may be An×An where A is the number of selected polarizing angles.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A spectral radiation detector comprising:
at least one lenslet with a circular blazed grating for diffraction of radiation to a focal plane;
a detector at the focal plane receiving radiation passing through the at least one lenslet for detection at a predetermined diffraction order; and,
at least one order filter associated with the at least one lenslet to pass radiation at wavelengths corresponding to the predetermined diffraction order.

2. The spectral radiation detector as defined in claim 1 wherein the at least one lenslet comprises an array of lenslets for a set of wavelengths, each lenslet having a circular blazed grating for diffraction of an associated wavelength from the set at nth order to the focal point and
wherein the at least one order filter comprises an array of order filters equal in number to the array of lenslets, each order filter in the array associated with one lenslet of the array to pass radiation at wavelengths corresponding to the predetermined order.

3. The spectral radiation detector as defined in claim l wherein the order filter comprises a thin film filter integrated on a substrate.

4. The spectral radiation detector as defined in claim 3 wherein the at least one lenslet is integral to the substrate.

5. The spectral radiation detector as defined in claim 1 where in the order filter comprises a Fabry-Perot filter.

6. The spectral radiation detector as defined in claim 1 further comprising at least one polarizing filter associated with the at least one lenslet.

7. The spectral radiation detector as defined in claim 2 wherein the array of lenslets includes at least two lenslets for each wavelength in the set and further comprising at least two polarizing filters having different polarization each associated with a respective one of the at least two lenslets for each wavelength.

8. The spectral radiation detector as defined in claim 7 wherein the array of lenslets comprises a plurality of lenslet quads, each lenslet quad having four circular blazed gratings for diffraction of a wavelength in the set at nth order, and wherein the at least two polarizing filters comprise a polarizing filter quad, each polarizing filter in the polarizing filter quad associated with a respective one of the lenslets in the lenslet quad.

9. The spectral radiation detector as defined in claim 7 wherein each lenslet in the lenslet array is on a substrate and the associated order fitter and associated polarizing filter are integrated on the substrate with thin film technology

10. The spectral radiation detector as defined in claim 2 wherein the lenslet array is translatable along an optical axis for tuning of transmitted wavelengths.

11. The spectral radiation detector as defined in claim 2 wherein the set of wavelengths incorporates N wavelengths and the lenslet array incorporates n×n lenslets

12. The spectral radiation detector as defined in claim 7 wherein the set of wavelengths incorporates N wavelengths and the lenslet array incorporates An×Bn lenslets where A+B is the number of polarizing filters associated with each wavelength.

13. A spectral radiation detector comprising:
a collimating lens passing radiation;
an array of lenslets for a set of wavelengths from the collimating lens, each lenslet having a circular blazed grating for diffraction of an associated wavelength from the set at nth order to the focal plane;
a detector at the focal plane receiving radiation passing through array of lenslets for detection of wavelengths at a predetermined order; and,
an array of order filters equal in number to the array of lenslets, each order filter in the array intermediate the collimating lens and an associated one lenslet of the array to pass radiation at wavelengths corresponding to the predetermined order.

14. The spectral radiation detector as defined in claim 13 further comprising:
an array of polarizing filters, each polarizing filter in the array intermediate the collimating lens and an associated one lenslet of the array.

15. The spectral radiation detector as defined in claim 14 wherein the set of wavelengths includes N wavelengths and the array of polarizing filters comprises A×n polarizing filters.

16. The spectral radiation detector as defined in claim 14 wherein the set of wavelengths includes N wavelengths and the array of lenslets comprises an array of lenslet quads, the blazed grating of lenslets in each lenslet quad diffracting one wavelength of the set and wherein the array of polarizing filters comprises an array of polarizing filter quads, each polarizing filter in each quad having a selected polarization and each polarizing filter quad associated with one lens let quad

17. The spectral radiation detector as defined in claim 13 wherein the predetermined order is 3^{rd} order.
